(19) United States
(12) Patent Application Publication
(10) Pub. No.: US 2025/0244178 A1
(43) Pub. Date: Jul. 31, 2025

(54) Surface Temperature Sensor

(71) Applicant: WIKA Alexander Wiegand SE & Co. KG, Klingenberg (DE)

(72) Inventors: Adam Delancey, Pearland, TX (US); Kyle Wilkinson, Edmonton (CA); Sandeep Malhotra, Houston, TX (US); Michael Tier, Pearland, TX (US); Ulrich Staab, Biebergemünd (DE)

(21) Appl. No.: 19/036,695

(22) Filed: Jan. 24, 2025

Related U.S. Application Data
(60) Provisional application No. 63/625,387, filed on Jan. 26, 2024.

(51) Int. Cl. G01K 1/143; G01K 7/06

(52) U.S. Cl. CPC G01K 1/143; G01K 7/06

(57) ABSTRACT

The invention relates to a surface temperature sensor, comprising a mounting body with an insertion opening, a housing chamber accessible through the insertion opening, a contact section at a bottom side of the mounting body, and a first sensor element receptacle that is accessible from within the housing chamber and is positioned adjacent to the contact section, and a thermocouple sensor cable with a metal sheath with an opening at an end section, an insulation material within the sheath, and a first pair of dissimilar conductor wires arranged within the sheath, wherein leading ends of the dissimilar conductor wires extend from the opening at the end section of the metal sheath, wherein the ends of the first pair of dissimilar conductor wires are connected to each other to form a first junction, wherein the mounting body further comprises at least one spacing protrusion on or adjacent to the contact section, that protrudes beyond an outer surface of the contact section.

### FIELD OF THE INVENTION

This invention pertains to temperature sensing technology, particularly to surface temperature sensors, and more particularly to mounting bodies for connection of sheathed, mineral insulated thermocouples onto a surface, the temperature of which is to be sensed.

### BACKGROUND OF THE INVENTION

There is a demand from many industries to accurately monitor the temperature of operating equipment in harsh environments, e.g. on the surface of pipes in heat exchangers or furnaces and other structures in industrial process plants. Sensors specifically adapted for such applications are sometimes also referred to as ‘tube-skin’ sensors.

The use of thermocouple sensors (hereinafter TC sensors) has widely been applied to that field, as they are known for reliability and fast response. As there are numerous different kinds of TC sensors, e.g. type K, J, E, and others, a suitable type of TC can be found for a wide range of specifications and applications.

A TC sensor comprises a set of two metal wires of different materials, that are connected to each other on one end, to form a so-called ‘hot junction’. If the hot junction is exposed to a different temperature than the other ends of the wires, then a voltage can be measured between these open ends, which voltage is indicative of the temperature difference between the hot junction and the open ends of the wires. By connecting the open ends of the wires to suitable measurement circuitry, accurate temperature measurement can be achieved.

To protect the TC wires from harsh environments, so-called sheathed sensor cables are widely used in the industry. The sheath of such cable is typically made of a steel, wherein the TC wires are embedded in an insulation material within the sheath. The insulation material is usually an inorganic mineral powder. In applications like heat exchangers, furnaces and similar structures, the sheathed sensor cables are particularly introduced into a chamber of the structure through a sealed process connection. The sheathed sensor cable is then routed within that chamber, so that a hot junction of the TC sensor, which is usually located at the end of the sheathed sensor cable, reaches a specific surface spot, where temperature measurement is desired. That specific surface spot may also be referred to as the ‘measurement location’ throughout this document.

To facilitate accurate positioning of the hot junction at the desired measurement location, firm connection to the surface and protection of the TC sensor and its hot junction from the environmental conditions at that measurement location, a variety of different mounting concepts have been employed. Amongst those, the use of so-called ‘V-shaped’ or ‘knife-edged’ mounting bodies has emerged as a means for a very reliable connection of the TC sensor to a surface and also for promotion of fast response times and higher accuracy of the temperature measurement. Such a device is known, for example, from the U.S. Pat. No. 5,141,335 A.

For the purpose of a concise specification of the above-mentioned prior art, as well as of the aspects and embodiments of the invention presented in following sections, terms like ‘top’, ‘upside’, ‘upper’ and similar wording shall be understood as referring to faces, sides or parts that are facing away from the surface, whose temperature is to be measured, or that are at least farther away from that surface than other faces, sides or parts. Accordingly, terms like ‘bottom’, ‘downside’, ‘ground’, ‘lower’ and similar wording shall be understood as referring to faces, sides or parts that are facing towards the surface, whose temperature is to be measured, or that are in direct physical contact with that surface or that are at least closer to that surface than other faces, sides or parts.

As illustrated in FIG. 1A, a temperature sensor 1000 with a V-shaped or knife-edged mounting body 1100 from the prior art is characterized by a contact section 1130 formed by an apex of a ridge 1150 at a bottom side thereof, wherein that ridge 1150 is defined by two inclined faces 1160, 1160′. The faces 1160, 1160′ may be parallel to a common axis, which may be referred to as a longitudinal axis of the mounting body 1100, and may be tilted by an angle, e.g. of 90 degrees to 140 degrees between each other. The faces 1160, 1160′ may meet at a sharp edge, or the apex of the ridge 1150 may be formed by a rounded or flat intermediate section between the inclined faces 1160, 1160′, as shown in FIG. 1B. With the ridge 1150, the contact section 1130 is adapted to make a defined contact with a surface 2000 of a structure, whose temperature is to be measured.

As further illustrated in FIG. 1C, the V-shaped or knife-edged mounting bodies from the prior art are characterized by an insertion opening 1110, through which a sheathed TC sensor cable 1300 may be introduced into a housing chamber 1120 inside of the mounting body 1100. For reliable protection from environmental influences, the sensor cable 1300 is sealingly fixed in the insertion opening 1110 by a circumferential welding 3000. An end portion of the sheathed TC sensor cable 1300, that is inserted into the insertion opening 1110, comprises an opening 1320, so that leading ends of at least a first pair 1340 of dissimilar conductor wires extend from the opening 1320 into the housing chamber 1120. The leading ends are connected to form a first junction 1350 which is positioned inside a sensor element receptacle 1140. This sensor element receptacle 1140 is formed as a bore through the contact section 1130 into the housing chamber 1120. When the first junction 1350 is positioned inside the sensor element receptacle 1140, the latter is then filled and closed from the outside by a welding 3000, thereby also welding the first junction 1350 into the sensor element receptacle 1140, so that it is fixed in this position and in very good thermal contact with the contact section 1130 of the mounting body 1100. The mounting body 1100 is then placed onto a surface 2000 of an object, e.g. of a pipe, whose temperature is to be measured, with its contact section 1130 facing downwards to the surface 2000, so that the contact section 1130 gets into direct physical contact with the surface 2000. The mounting body 1100 is then fixedly connected to the surface 2000 by another circumferential welding 3000.

The inventors of the present invention have noticed that measurement accuracy and long-term stability of the sensor signal as well as of the integrity of the sensor assembly itself, highly depend on the quality of the welding connection between the mounting body and the surface that it is welded onto. Furthermore, the inventors have noticed that recalibration and condition monitoring of surface temperature sensors would desirable to increase lifetime of such sensor devices and to prevent unexpected failures. The present invention and its different aspects aim to overcome the deficiencies of the prior art.

### SUMMARY OF THE INVENTION

The object of the present invention is to provide a surface temperature sensor.

According to the invention, the object is achieved with a surface temperature sensor according to claim 1.

Embodiments of the invention are subject of the dependent claims.

According the invention, a surface temperature sensor comprises a mounting body and a thermocouple sensor cable. The mounting body is made of a thermally conducting material, and comprises an insertion opening, a housing chamber accessible through the insertion opening, a contact section at a bottom side of the mounting body, and a first sensor element receptacle that is accessible from within the housing chamber and is positioned adjacent to the contact section. The thermocouple sensor cable comprises a metal sheath with an opening at an end section, an insulation material within the sheath, and a first pair of dissimilar conductor wires arranged within the sheath, wherein leading ends of the dissimilar conductor wires extend from the opening at the end section of the metal sheath, wherein the ends of the first pair of dissimilar conductor wires are connected to each other to form a first junction. The end section of the thermocouple sensor cable is inserted into the insertion opening of the mounting body and sealingly connected to it by welding. Therefore, the leading ends of the dissimilar conductor wires and the first junction protrude into the housing chamber. The first junction is positioned in the first sensor element receptacle and welded to the mounting body within the first sensor element receptacle.

In a first aspect of the invention, the mounting body further comprises at least one spacing protrusion on or adjacent to the contact section, that protrudes beyond an outer surface of the contact section. That means, the spacing protrusion projects from the outer surface of the contact section downwardly. When the surface temperature sensor is placed on a surface, whose temperature is to be measured, the spacing protrusion-as it is the part of the mounting body, which projects the farthest from the bottom side of the mounting body-is in direct physical contact with the surface, while the remaining parts of the contact section are spaced from the surface by a distance defined by the height of the spacing protrusion. In other words, a defined gap between the surface of the object or structure, whose surface temperature is to be measured, and the contact section is created by the spacing protrusion. When the mounting body is welded onto the surface, this defined gap will be filled with the welding material, thereby eliminating any gaps or air holes between the mounting body and the surface. Therefore, a very reliable, stable thermal contact between the surface and the first junction (which is welded into the sensor element receptacle at or close to the outer surface of the contact section) can be achieved. The surface temperature sensor therefore has an improved long-term stability and measurement accuracy. The risk of a low-quality welding connection is significantly reduced, as the defined gap will be fully penetrated by the welding material.

In an exemplary embodiment of the first aspect of the invention, the at least one spacing protrusion protrudes 0.02 inches to 0.13 inches (0.51 mm to 3.3 mm) beyond the outer surface of the contact section, particularly about 0.03 inches (0.762 mm). That protrusion dimension may also be referred to as the height of the spacing protrusion. The given dimensions provide for a very reliable penetration of the welding into the gap between the contact section and the surface of the object or structure.

In another exemplary embodiment of the first aspect of the invention, a height of the at least one spacing protrusion-which means the length over which the spacing protrusion protrudes from the outer surface of the contact section-is adapted to a width of the contact section-which means the distance between opposing edges of the contact section, below which the defined gap is created, that should be penetrated completely by the welding material-wherein the height of the spacing protrusion is at least 50% and not more than 200%, particularly not more than 150%, of the width of the contact section. This relation provides for a very reliable penetration of the welding into the gap between the contact section and the surface of the object or structure and is adaptable to a wide range of differently sized mounting bodies for surface temperature sensors.

In another exemplary embodiment of the first aspect of the invention, the mounting body comprises at least two spacing protrusions, wherein the first sensor element receptacle is positioned between a first and a second spacing protrusion of the at least two spacing protrusions. The provision of more than one spacing protrusion can effectively reduce or eliminate the risk of a tilting of the mounting body relative to the surface (about an axis perpendicular to a straight line between the two spacing protrusions and parallel to the surface), therefore ensuring a constant, defined gap between the surface of the structure or object, and the contact section. In a further example, the first sensor element receptacle is positioned essentially in the middle of a straight line between the first and second spacing protrusions. ‘Essentially’ means in this context, that a deviation from the exact middle shall be not more than 25% of the total distance between the first and second spacing protrusion. Therefore, a thorough welding penetration on both sides of the sensor element receptacle can be achieved.

In another exemplary embodiment of the first aspect of the invention, the contact section is formed by an apex of a downwardly tapered main ridge, which is defined by two inclined main faces on the mounting body, wherein the main ridge extends at least partially along a longitudinal axis of the mounting body and the first sensor element receptacle is positioned within the main ridge. The apex may be formed by a sharp edge or by a rounded or flat intermediate section between the inclined faces. Such a contact section may be referred to as ‘V-shaped’ or ‘knife-edged’, as known from the prior art. In this embodiment, the contact section has a narrow width. In light of the teaching of a preceding embodiment—namely, that the height of the spacing protrusion shall be between 50% and 200% of the width of the contact section for optimal welding—only a relatively small spacing protrusion is necessary in this embodiment to achieve a full penetration of the defined gap by welding material. Also, the design of the contact section according to this embodiment provides for a narrow, defined and precise thermal contact of the temperature sensor to the surface and therefore improves measurement accuracy and reduces response time.

In an exemplary advancement of this embodiment, the inclined main faces are tilted by an angle αₚᵣᵢₘ of 90° to 140° between each other.

In another exemplary advancement of this embodiment, the at least one spacing protrusion is formed by a downwardly tapered secondary ridge, which is defined by two inclined secondary faces, wherein the secondary ridge is formed on or adjacent to the main ridge. In this advancement, manufacturing of the mounting body is particularly easy and cost-efficient. In a further example of this advancement, the secondary faces are tilted by an angle α_{sec} between each other, that is smaller than or equal to the angle αₚᵣᵢₘ between the inclined main faces of the main ridge.

In another exemplary advancement of this embodiment, the main ridge comprises a sensing section that is recessed, and at least one spacing section that is either not recessed or at least less recessed than the sensing section, wherein the at least one spacing protrusion is formed by that at least one spacing section and wherein the first sensor element receptacle is positioned within the sensing section. In this advancement, manufacturing of the mounting body is also particularly easy and cost-efficient.

In another exemplary embodiment of the first aspect of the invention, the mounting body further comprises a second sensor element receptacle that is accessible from within the housing chamber and is positioned adjacent to a top side of the mounting body, and a second pair of dissimilar conductor wires is arranged within the sheath of the thermocouple sensor cable. Leading ends of this second pair of dissimilar conductor wires extend from the opening at the end section of the metal sheath, together with the leading ends of the first pair of metal wires, wherein the ends of the second pair of dissimilar conductor wires are connected to each other to form a second junction. That second junction is positioned in the second sensor element receptacle and welded to the mounting body within that second sensor element receptacle. Therefore, the second junction is embedded in the upper surface of the mounting body, which faces away from the surface of the structure and is exposed to the same atmosphere or environment, that surrounds the structure or object, whose surface temperature is to be measured. The second junction can therefore be used to measure the temperature of the upper side of the mounting body. The measurement value from this measurement can be compared to readings of an infra-red camera, that may be pointed at the surface temperature sensor's upper surface. Therefore, the temperature measurement with the second junction can be calibrated or recalibrated at any time. Furthermore, readings from the first and second junction can be compared. In normal operation, there should be a relatively constant offset between them. However, an increasing offset can indicate a damage or drift of at least one of them. If such increase is detected, the sensor can be booked for replacement at the next possible opportunity. Also, if the first junction should be damaged, the second junction may be used to estimate the surface temperature of the structure or object.

In another exemplary embodiment of the first aspect of the invention, the second sensor element receptacle is formed by a bore through the top side of the mounting body into the housing chamber. When the second junction is positioned inside the second sensor element receptacle, the latter is then filled and closed from the outside by a welding, thereby also welding the second junction into the second sensor element receptacle, so that it is fixed in this position and in very good thermal contact with the outer surface at the top of the mounting body.

In another exemplary embodiment of the first aspect of the invention, the second pair of dissimilar conductor wires comprises at least one conductor wire that is made of a material that is different from the material of both conductor wires of the first pair of dissimilar conductor wires. I.e., the second junction is of a different thermocouple type than the first junction. This embodiment provides for an increased effectiveness of this aspect of the invention, regarding its ability to detect drift or failure of one of the junctions. As junctions of different types show different drifting and deterioration characteristics, it is more likely in this embodiment, that both junctions will not drift or deteriorate in a similar way, so that the drift or deterioration of one of them or of both will very likely result in an increased offset between their respective measurement readings.

In another exemplary embodiment of the first aspect of the invention, the surface temperature sensor further comprises a positioning body with a shaped bottom side that matches a surface that the surface temperature sensor is to be mounted on, and a bridge body. The bridge body rigidly connects the positioning body and the mounting body and a bottom side of the bridge body is recessed in relation to the contact section and the shaped bottom side. As the positioning body's bottom side matches the surface of the object or structure, on which the surface temperature sensor is to be mounted on, it forms a flat, areal contact with that surface. That provides for a stable placement of the sensor on the surface and eliminates or at least reduces the risk of tilting or tipping significantly. As surface temperature sensors need to be temporarily fixed to the structure, e.g. by chain clamps, before they can be permanently fixed to it by welding, the process is further simplified: Such chain clamps (or different clamping or gripping means) can be attached to the positioning body. As the mounting body is fixedly connected to the positioning body through the bridge body, the mounting body therefore is indirectly fixed as well and can be welded to the surface. At the same time, welding of the mounting body is substantially easier, as the mounting body is not partly covered by the chain clamp or similar clamping or gripping means. Since a bottom side of the bridge body is recessed in relation to the contact section and the shaped bottom side (i.e. recesses to the bottom sides of the mounting body and the positioning body), the contact section is accessible for all around welding, even below the bridge section. Therefore, the mounting body can firmly be connected to the surface on all sides and the contact section, in particular the spot where the first sensor element receptacle is positioned in the contact section, is completely sealed off from the surrounding atmosphere by a welding seam. That may provide for an increased durability of the surface temperature sensor, and can greatly reduce detrimental environmental influences.

In another exemplary embodiment of the first aspect of the invention, the contact section of the mounting body is slightly recessed in relation to the shaped bottom side of the positioning body. Therefore, when the positioning body of the surface temperature sensor is placed on the surface, whose temperature is to be measured, the contact section of the mounting body is held spaced from the surface by a defined distance, forming a defined gap between contact section and surface. That gap can serve for the same purpose as the gap defined by the spacing protrusion according to the first aspect of the invention: when the mounting body is circumferentially welded to the surface, that gap will be filled with the welding material, thereby eliminating any gaps or air holes between the mounting body and the surface. Hence, this embodiment combines the third aspect of the invention with the beneficial effect of the first aspect, without the need to provide one or more spacing protrusions on the bottom side of the mounting body or on the contact section.

In another exemplary embodiment of the first aspect of the invention, the positioning body and the bridge body are made of the same thermally conducting material as the mounting body, e.g. stainless steel. That provides for a good protection of the device from damage and environmental influences and enables a stable rigid connection of all three body, e.g. by welding.

In another exemplary embodiment of the first aspect of the invention, the mounting body, the bridge body and the positioning body are integrally formed, e.g. permanently connected to each other by welding, or cut from one single piece. Therefore, the structure of the surface temperature sensor is very stable and durable.

In a second aspect of the invention, the mounting body further comprises a second sensor element receptacle that is accessible from within the housing chamber and is positioned adjacent to a top side of the mounting body, and a second pair of dissimilar conductor wires is arranged within the sheath of the thermocouple sensor cable. Leading ends of this second pair of dissimilar conductor wires extend from the opening at the end section of the metal sheath, together with the leading ends of the first pair of metal wires, wherein the ends of the second pair of dissimilar conductor wires are connected to each other to form a second junction. That second junction is positioned in the second sensor element receptacle and welded to the mounting body within that second sensor element receptacle. Therefore, the second junction is embedded in the upper surface of the mounting body, which faces away from the surface of the structure and is exposed to the same atmosphere or environment, that surrounds the structure or object, whose surface temperature is to be measured. The second junction can therefore be used to measure the temperature of the upper side of the mounting body. The measurement value from this measurement can be compared to readings of an infra-red camera, that may be pointed at the surface temperature sensor's upper surface. Therefore, the temperature measurement with the second junction can be calibrated or recalibrated at any time. Furthermore, readings from the first and second junction can be compared. In normal operation, there should be a relatively constant offset between them. However, an increasing offset can indicate a damage or drift of at least one of them. If such increase is detected, the sensor can be booked for replacement at the next possible opportunity. Also, if the first junction should be damaged, the second junction may be used to estimate the surface temperature of the structure or object.

In an exemplary embodiment of the second aspect of the invention, the second sensor element receptacle is formed by a bore through the top side of the mounting body into the housing chamber. When the second junction is positioned inside the second sensor element receptacle, the latter is then filled and closed from the outside by a welding, thereby also welding the second junction into the second sensor element receptacle, so that it is fixed in this position and in very good thermal contact with the outer surface at the top of the mounting body.

In another exemplary embodiment of the second aspect of the invention, the second pair of dissimilar conductor wires comprise at least one conductor wire that is made of a material that is different from the material of both conductor wires of the first pair of dissimilar conductor wires. I.e., the second junction is of a different thermocouple type than the first junction. This embodiment provides for an increased effectiveness of this aspect of the invention, regarding its ability to detect drift or failure of one of the junctions. As junctions of different types show different drifting and deterioration characteristics, it is more likely in this embodiment, that both junctions will not drift or deteriorate in a similar way, so that the drift or deterioration of one of them or of both will very likely result in an increased offset between their respective measurement readings.

In another exemplary embodiment of the second aspect of the invention, the contact section is formed by an apex of a downwardly tapered main ridge, which is defined by two inclined main faces on the mounting body, wherein the main ridge extends at least partially along a longitudinal axis of the mounting body and the first sensor element receptacle is positioned within the main ridge. The apex may be formed by a sharp edge, or by a rounded or flat intermediate section between the inclined faces. Such a contact section may be referred to as ‘V-shaped’ or ‘knife-edged’, as known from the prior art. The design of the contact section according to this embodiment provides for a narrow, defined and precise thermal contact of the temperature sensor to the surface and therefore improves measurement accuracy and reduces response time.

In a third aspect of the invention, the surface temperature sensor further comprises a positioning body with a shaped bottom side that matches a surface that the surface temperature sensor is to be mounted on, and a bridge body. The bridge body rigidly connects the positioning body and the mounting body and a bottom side of the bridge body is recessed in relation to the contact section and the shaped bottom side. As the positioning body's bottom side matches the surface of the object or structure, on which the surface temperature sensor is to be mounted on, it forms a flat, areal contact with that surface. That provides for a stable placement of the sensor on the surface and eliminates or at least reduces the risk of tilting or tipping significantly. As surface temperature sensors need to be temporarily fixed to the structure, e.g. by chain clamps, before they can be permanently fixed to it by welding, the process is further simplified: Such chain clamps (or different clamping or gripping means) can be attached to the positioning body. As the mounting body is fixedly connected to the positioning body through the bridge body, the mounting body therefore is indirectly fixed as well and can be welded to the surface. At the same time, welding of the mounting body is substantially easier, as the mounting body is not partly covered by the chain clamp or similar clamping or gripping means. Since a bottom side of the bridge body is recessed in relation to the contact section and the shaped bottom side (i.e. recesses to the bottom sides of the mounting body and the positioning body), the contact section is accessible for all around welding, even below the bridge section. Therefore, the mounting body can firmly be connected to the surface on all sides and the contact section, in particular the spot where the first sensor element receptacle is positioned in the contact section, is completely sealed off from the surrounding atmosphere by a welding seam. That may provide for an increased durability of the surface temperature sensor, and can greatly reduce detrimental environmental influences.

In an exemplary embodiment of the third aspect of the invention, the insertion opening is arranged on the mounting body, like it is the case in the first and second aspect of the invention. In a further exemplary embodiment, the insertion opening and the bridge body are arranged on opposing sides of the mounting body. For example, the mounting body may extend along a longitudinal axis between a front face and a back face, wherein the insertion opening is arranged on the front face and the bridge body is connected to the mounting body on the back face. With such a design, the surface temperature sensor can be kept small in size and can be handled more easily during installation.

However, in contrast to the first and second aspect of the invention, the surface temperature sensor according to the third aspect the invention not only comprises the mounting body, but also the bridge body and the positioning body. Therefore, the insertion opening, through which the thermocouple sensor cable may be inserted and through which the housing chamber is accessible, does not need to be arranged directly on the mounting body.

Accordingly, in another exemplary embodiment, the insertion opening is arranged on positioning body and a guiding channel extends from the opening through the positioning body and through the bridge body, into the housing chamber of the mounting body. After the end section of thermocouple sensor cable is inserted into the insertion opening and the metal sheath is carefully welded into the opening (i.e., a small welding seam is carefully formed between the sheath and the inner surrounding edge of the insertion opening) and the first pair of dissimilar conductor wires, which extend from the open end section of the cable, are routed through the guiding channel to reach the housing chamber and the first sensor element receptacle. In a further exemplary embodiment, the insertion opening is arranged on the positioning body with the lower edge of the opening nearly flush with the bottom side of the positioning body. In this embodiment, the thermocouple sensor cable can be routed basically in a straight line to the insertion opening and can enter it without needing to be bent in a step-like shape to enter an insertion opening that is spaced from the ground. Such spacing from the ground is usually necessary, as surface temperature sensors need to be welded all around the contact sections of their mounting body. If the sheathed thermocouple sensor cable would enter such a mounting body basically flush with the ground, the welding could either not be completed around the insertion opening, or there would be a high risk that the thin metal sheath is damaged during the welding. However, in this embodiment, the insertion opening is completely separated from the mounting body and therefore, there is no risk to damage it during the circumferential welding around the contact section. The straight, flush entry of the thermocouple sensor cable, in turn, simplifies handling of the surface temperature sensor during installation and reduces the risk of damage to the sensor cable through environmental influences.

In another exemplary embodiment of the third aspect of the invention, the contact section of the mounting body is slightly recessed in relation to the shaped bottom side of the positioning body. Therefore, when the positioning body of the surface temperature sensor is placed on the surface, whose temperature is to be measured, the contact section of the mounting body is held spaced from the surface by a defined distance, forming a defined gap between contact section and surface. That gap can serve for the same purpose as the gap defined by the spacing protrusion according to the first aspect of the invention: when the mounting body is circumferentially welded to the surface, that gap will be filled with the welding material, thereby eliminating any gaps or air holes between the mounting body and the surface. Hence, this embodiment combines the third aspect of the invention with the beneficial effect of the first aspect, without the need to provide one or more spacing protrusions on the bottom side of the mounting body or on the contact section.

In another exemplary embodiment of the third aspect of the invention, the positioning body and the bridge body are made from the same thermally conducting material as the mounting body, e.g. stainless steel. That provides for a good protection of the device from damage and environmental influences and enables a stable rigid connection of all three bodies, e.g. by welding.

In another exemplary embodiment of the third aspect of the invention, the mounting body, the bridge body and the positioning body are integrally formed, e.g. permanently connected to each other by welding, or cut from one single piece. Therefore, the structure of the surface temperature sensor is very stable and durable.

In an exemplary embodiment of the invention, the second aspect is combined with the first aspect of the invention, i.e., the surface temperature sensor comprises all characteristic features of the second aspect and/or of any of the above-mentioned exemplary embodiments thereof, and also comprises all characteristic features of the first aspect as described in the foregoing and/or of any of the mentioned exemplary embodiments and advancements of the first aspect. Hence, the beneficial effects and improvements over the prior art of both aspects of the invention can be combined in a single surface temperature sensor.

In another exemplary embodiment of the invention, the second aspect is combined with the third aspect of the invention, i.e. the surface temperature sensor comprises all characteristic features of the second aspect and/or of any of the above-mentioned exemplary embodiments thereof, and also comprises all characteristic features of the third aspect as described in the foregoing and/or of any of the mentioned exemplary embodiments thereof. Hence, the beneficial effects and improvements over the prior art of both aspects of the invention can be combined in a single surface temperature sensor.

In another exemplary embodiment of the invention, the first aspect is combined with the third aspect of the invention, i.e. the surface temperature sensor comprises all characteristic features of the first aspect and/or of any of the above-mentioned exemplary embodiments and advancements thereof, and also comprises all characteristic features of the third aspect as described in the foregoing and/or of any of the mentioned exemplary embodiments thereof. Hence, the beneficial effects and improvements over the prior art of both aspects of the invention can be combined in a single surface temperature sensor. However, exemplary embodiments of the third aspect of the invention, in which a defined gap between contact section and surface is already created by a recession of the contact section in relation to the shaped bottom side of the positioning body, are excluded from combinations with the first aspect, as there is no need for additional spacing protrusions in such examples.

In another exemplary embodiment of the invention, all three aspects of the invention and/or any of their exemplary embodiments (under observation of the above-mentioned exclusion of one particular exemplary embodiment of the third aspect from combination with the first aspect) and advancements are combined, therefore resulting in a single surface temperature sensor that comprises all of the abovementioned benefits and improvements over the prior art.

In an exemplary embodiment of any or all aspects of the invention, the thermally conducting material is a stainless steel, so that the first junction is well protected from environmental influences.

In another exemplary embodiment of any or all aspects of the invention, the sensor element receptacle is formed by a bore through the contact section into the housing chamber. When the first junction is positioned inside the sensor element receptacle, the latter is then filled and closed from the outside by a welding, thereby also welding the first junction into the sensor element receptacle, so that it is fixed in this position and in very good thermal contact with the contact section of the mounting body.

In another exemplary embodiment of any or all aspects of the invention, the insulation material is an inorganic mineral powder.

In another exemplary embodiment auf any of all aspects of the invention, the inside of the housing chamber and the guiding channel (if present) are filled up with an insulation material, after the first junction and second junction (if present) are placed and fixed in their respective sensor element receptacles. Therefore, short circuits between the conductors, except for the prepared first junction and second junction (if present) are prevented.

It shall be understood that in all aspects of the invention, the mounting body, and the bridge body and the positioning body (if present) may have more openings then just the one insertion opening. With such additional openings, routing and placement of the first pair and second pair (if present) of dissimilar conductors inside of the housing chamber and inside of the guiding channel (if present) can be simplified. When the junctions are each placed and fixed to their respective sensor element receptacles and the housing chamber and guiding channel (if present) are filled up with insulation material, such additional openings may eventually be covered with suitable housing caps and sealed, e.g. by welding.

Further scope of applicability of the present invention will become apparent from the detailed description given hereinafter. However, it should be understood that the detailed description and specific examples, while indicating exemplary embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus, are not limitative of the present invention, and wherein:

FIG. 1A schematically shows an exemplary embodiment of a surface temperature sensor from the prior art in a perspective view,

FIG. 1B schematically shows another exemplary embodiment of a surface temperature sensor from the prior art in a perspective view,

FIG. 1C schematically shows another exemplary embodiment of a surface temperature sensor from the prior art in a cross-sectional view,

FIG. 2A schematically shows an exemplary embodiment of a surface temperature sensor in a perspective view,

FIG. 2B schematically shows the embodiment of FIG. 2A in a side view,

FIG. 2C schematically shows the embodiment of FIG. 2A and 2B in a front view,

FIG. 2D schematically shows another exemplary embodiment of a surface temperature sensor in a front view,

FIG. 3A schematically shows another exemplary embodiment of a surface temperature sensor in a perspective view,

FIG. 3B schematically shows the embodiment of FIG. 3A in a side view,

FIG. 4A schematically shows another exemplary embodiment of a surface temperature sensor in a perspective view,

FIG. 4B schematically shows the embodiment of FIG. 4A in a side view,

FIG. 5A schematically shows another exemplary embodiment of a surface temperature sensor in a perspective view,

FIG. 5B schematically shows the embodiment of FIG. 5A in a side view,

FIG. 6A schematically shows the embodiment from the prior art of FIG. 1C in a cross-sectional view,

FIG. 6B schematically shows a section of FIG. 6A in an enlarged, detailed view,

FIG. 7A schematically shows the embodiment of FIG. 2B in a cross-sectional view,

FIG. 7B schematically shows a section of FIG. 7A in an enlarged, detailed view,

FIG. 8 schematically shows another exemplary embodiment of a surface temperature sensor in a cross-sectional view,

FIG. 9A schematically shows another exemplary embodiment of a surface temperature sensor in a perspective view,

FIG. 9B schematically shows another exemplary embodiment of a surface temperature sensor in a perspective view,

FIG. 9C schematically shows the embodiment of FIG. 9B in a cross-sectional view,

FIG. 10A schematically shows another exemplary embodiment of a surface temperature sensor in a side view,

FIG. 10B schematically shows another exemplary embodiment of a surface temperature sensor in a side view,

FIG. 10C schematically shows another exemplary embodiment of a surface temperature sensor in a side view, and

FIG. 11 schematically shows another exemplary embodiment of a surface temperature sensor in a cross-sectional view.

### DETAILED DESCRIPTION

Throughout the following detailed description, equal reference numbers are assigned to corresponding parts of all following exemplary embodiments.

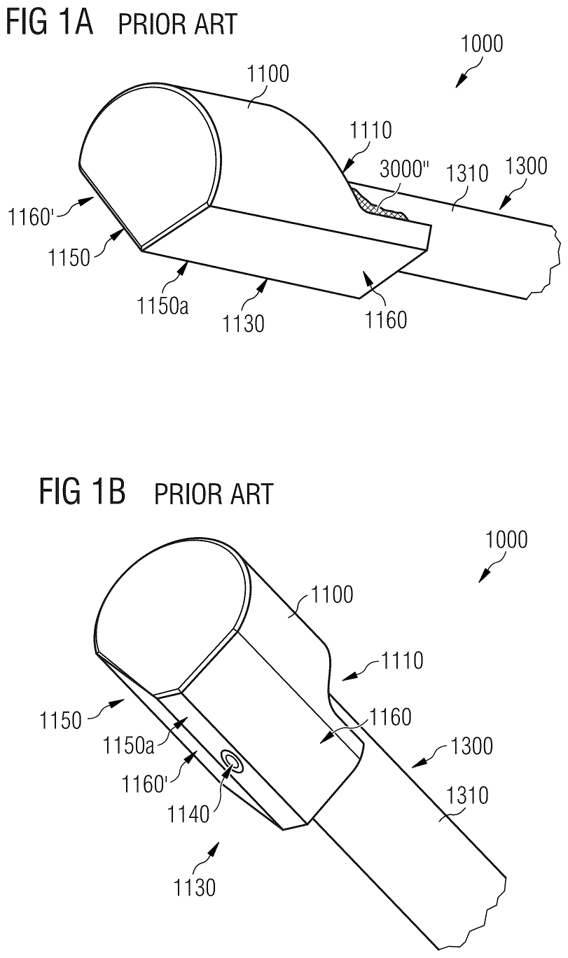

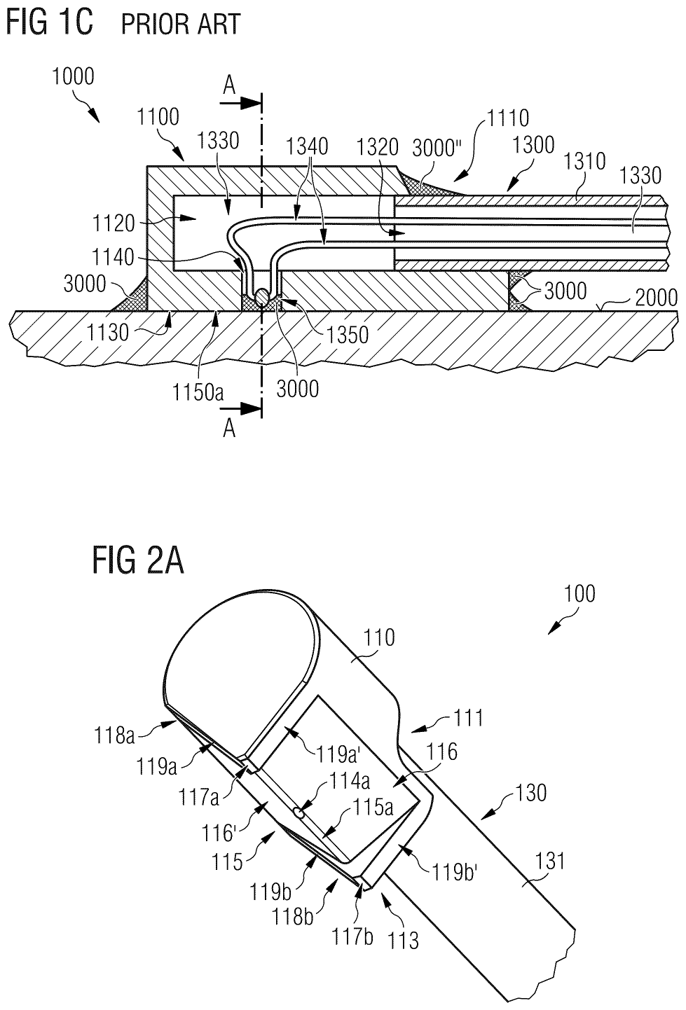

FIGS. 1A, 1B and 1C have been described in previous sections with regard to the prior art.

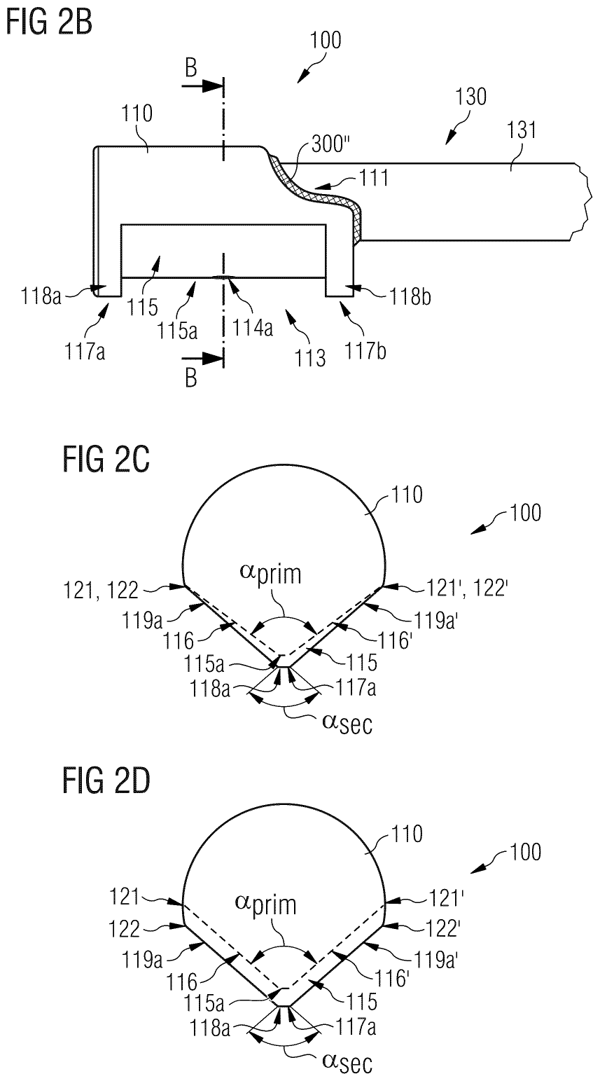

FIGS. 2A, 2B, 3A, 3B, 4A, 4B, 5A and 5B illustrate various exemplary embodiments of a surface temperature sensor 100 according to the first aspect of the invention, wherein each figure denoted with letter A illustrates an individual exemplary embodiment of the surface temperature sensor 100 in a perspective view, and each figure denoted with letter B illustrates the respective exemplary embodiment of the surface temperature sensor 100 in a side view.

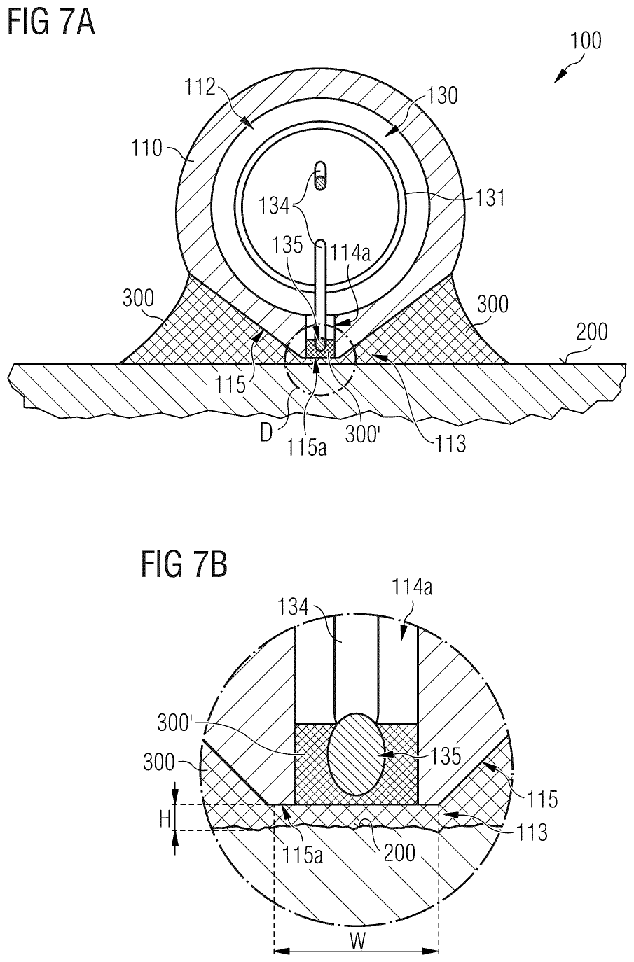

In these figures, each shown mounting body 110 comprises an insertion opening 111 through which an end section of the sheathed thermocouple sensor cable 130 is introduced into a housing chamber 112 (shown in FIG. 7A). A metal sheath 131 is carefully welded into the insertion opening 111 by a welding 300″, such that the thin metal sheath 131 is not damaged by the welding, while the thermocouple sensor cable 130 is fixed to the mounting body 110 and the insertion opening 111 is sealed. The mounting bodies 110 shown in all FIGS. 2A/B to 5A/B each comprise a contact section 113, that is adapted for a defined thermal contact with a surface 200 of a structure or an object, whose temperature is to be measured (surface 200 in FIG. 7A).

The mounting bodies 110 illustrated in FIGS. 2A/B to 4A/B comprise a contact section 113, that is formed by an apex 115a of a downwardly tapered main ridge 115. That main ridge 150 is defined by two inclined main faces 116, 116′.

In the exemplary embodiments illustrated in FIGS. 2A and 2B two spacing protrusions 117a, 117b are formed by two downwardly tapered secondary ridges 118a, 118b. Each secondary ridge 118a, 118b is defined by two inclined secondary faces 119a, 119a′ and 119b, 119b′, respectively. Between the spacing protrusions 117a, 117b, a first sensor element receptacle 114a (with a first junction 135 welded into it) is positioned in the main ridge 115.

As shown in a front view of the embodiment from FIGS. 2A and 2B (basically opposite to the insertion opening 111) in FIG. 2C, the main faces 116, 116′ form an angle αₚᵣᵢₘ between them, whereas the secondary faces 119a, 119a′ (and secondary faces 119b, 119b′ accordingly) of the embodiment in FIGS. 2A and 2B form an angle α_{sec} between them. In this example, the angle α_{sec} is smaller than the angle αₚᵣᵢₘ and side edges 121, 121′ of the inclined main faces 116, 116′ are aligned with side edges 122, 122′ of the secondary faces 119a, 119a′. As a result, apexes of the secondary ridges 118a, 118b protrude farther downwards than the apex 115a of the main ridge 115 to form the spacing protrusions 117a, 117b.

However, in an alternative design of this exemplary embodiment, as shown in a front view in FIG. 2D, the angles α_{sec} and αₚᵣᵢₘ are identical, but the main faces 116, 116′ are cut deeper into the mounting body 110 and therefore define different side edges 121, 121′ that are farther away from the bottom as the side edges 122, 122′ formed by the secondary faces 119a, 119a′ (and secondary faces 119b, 119b′ accordingly). Again, as a result, the apexes of the secondary ridges 118a, 118b protrude farther downwards than the apex 115a of the main ridge 115 to form the spacing protrusions 117a, 117b.

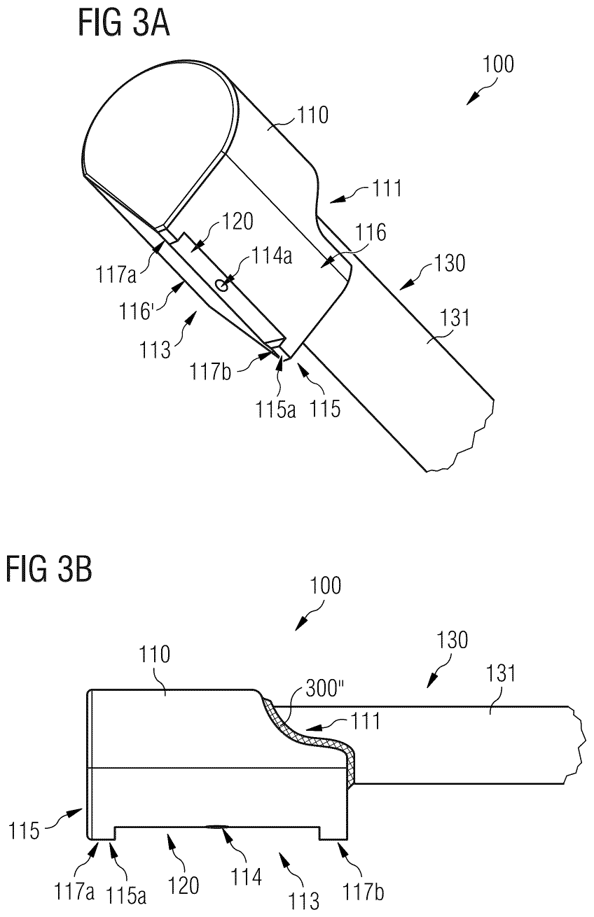

In the exemplary embodiment illustrated in FIGS. 3A and 3B, the main ridge 115 comprises a recessed sensing section 120 in the middle of it, thereby forming two spacing protrusions 117a, 117b by the surrounding sections of the apex 115a of the main ridge 115, that are not-or at least less-recessed than the recessed sensing section 120. This embodiment is particularly easy to manufacture and therefore very cost-efficient.

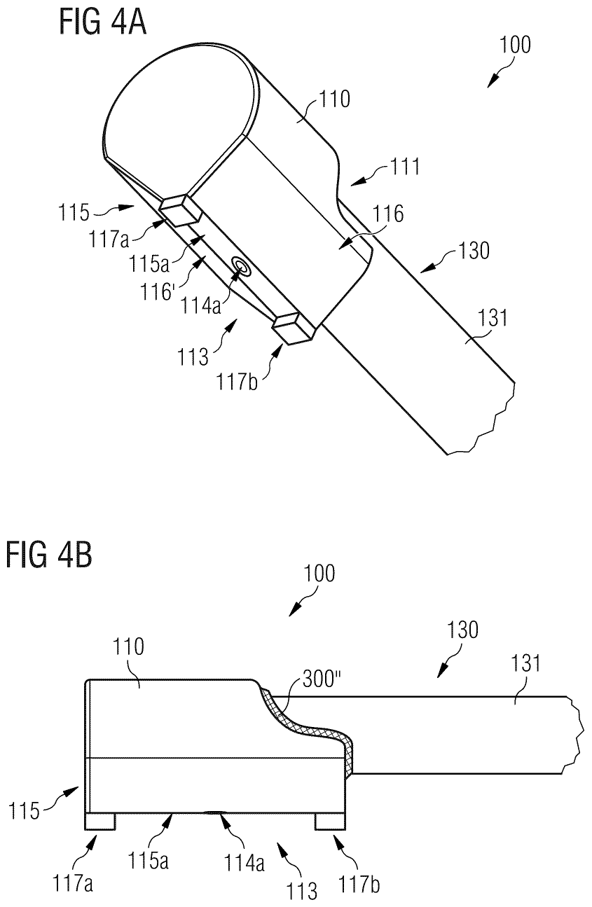

In the exemplary embodiment illustrated in FIGS. 4A and 4B, two spacing protrusions 117a, 117b in the form of spacer blocks are arranged on the apex 115a of the main ridge 115. The apex 115a is formed by a flat intermediate section, therefore the spacing protrusions 117a, 117b can be formed more easily on the apex 115a by additive methods, e.g. by welding. This embodiment can also be manufactured very easily and at low cost. However, in other exemplary embodiments, the spacing protrusions 117a, 117b may also be formed by cutting from the mounting body 110.

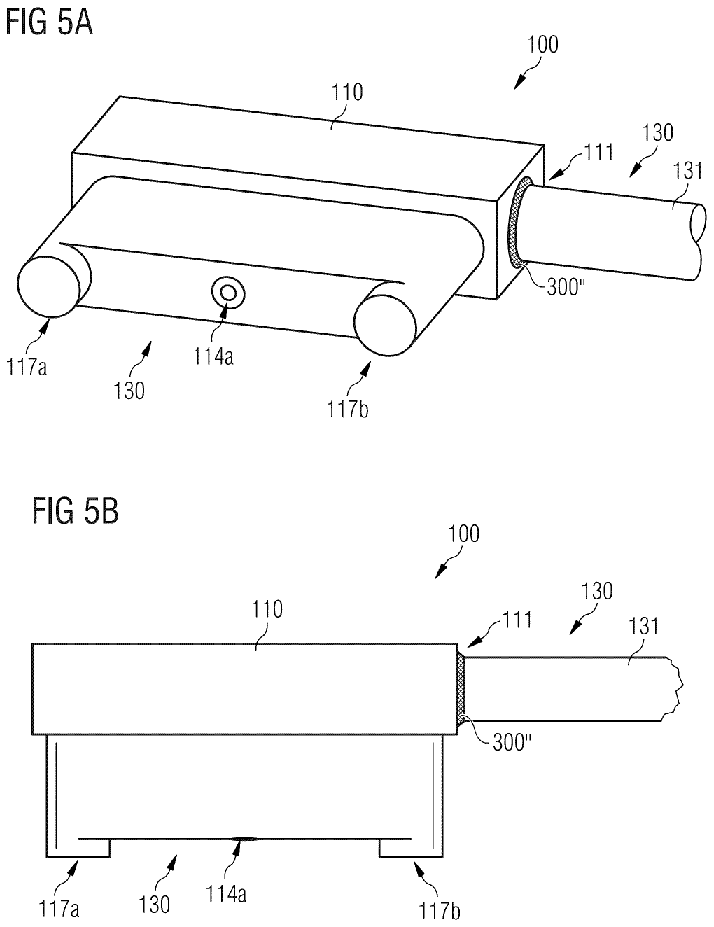

FIGS. 5A and 5B show an exemplary embodiment that mainly differs from the aforementioned ones in that it does not comprise a downwardly tapered main ridge 115. Instead, the contact section 113 is formed by a block-shaped body with not inclined side faces. Two spacing protrusions 117a, 117b protrude from a bottom face of the contact section 113, therefore forming a defined gap below a middle section of the contact section 113, where the first sensor element receptacle 114a is positioned within the mounting body 110.

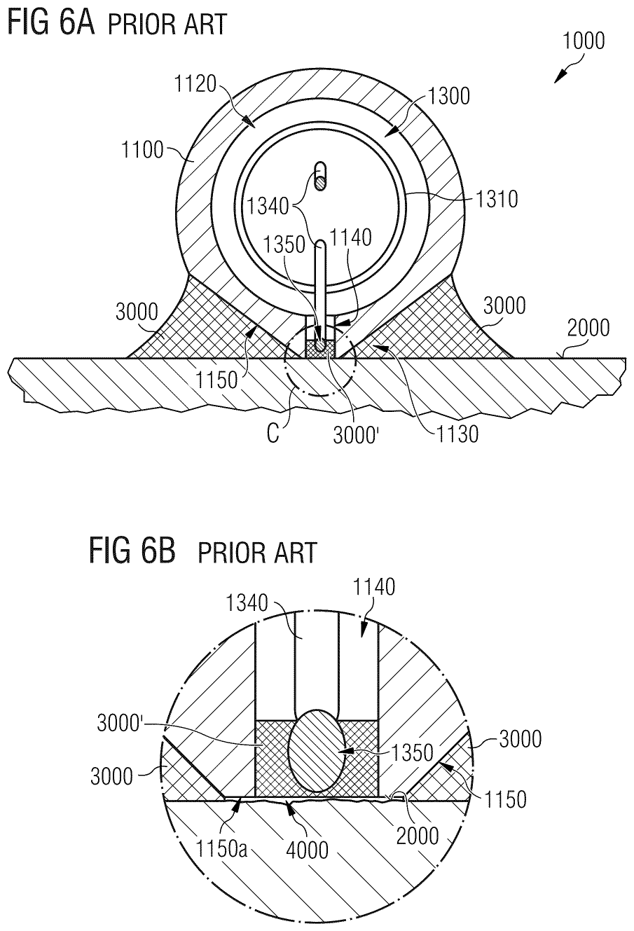

To further explain the beneficial effects, achieved by the first aspect of the invention, FIGS. 6A and 6B illustrate the prior art and a possible deficiency thereof: FIG. 6A shows a cross-sectional view of the exemplary embodiment of the surface temperature sensor 1000 from FIG. 1C. The sectional plane depicted in FIG. 6A is indicated in FIG. 1C with letter A. The mounting body 1100 is fixed to the surface 2000 by welding 3000. At the contact section 1300, that is formed by the apex of the downwardly tapered main ridge 1150, a thermocouple junction 1350 is arranged inside the sensor element receptacle 1140 and was fixed therein by a welding 3000′ beforehand. However, as shown in FIG. 6B in an enlarged illustration of a section of FIG. 6A, that is indicated with letter C, an air gap 4000 is formed—at least in patches—between the apex 1150a of the ridge 1150/the bottom face of the contact section 1130 and the surface 2000. That may be due to the surface roughness of the surface 2000, as illustrated herein, or due to an unintentional tilting or tipping of the mounting body 1100 during the installation process. Such air gaps 4000 degrade the thermal coupling between the thermocouple junction 1350 and the surface 2000, so that the measurement accuracy may decrease and/or response times may increase. The occurrence or at least the effect of this deficiency can be reduced, if the surface section, where the surface temperature sensor 1000 is mounted on the surface 2000, is cleaned and prepared very well before installation, and if the surface temperature sensor 1000 is placed and clamped to the surface 2000 very accurately and carefully during the installation process. Still, with the temperature sensor designs from the prior art, the problem cannot be eliminated systematically and it is also not possible to rule out the formation of such air gaps 4000 after completion of the welding process.

With the design according to the first aspect of the invention, however, the aforementioned problem can be eliminated, as illustrated in FIGS. 7A and 7B: FIG. 7A shows a cross-sectional view of the exemplary embodiment of the first aspect of the invention from FIGS. 2A and 2B. The sectional plane depicted in FIG. 7A is indicated in FIG. 2B with letter B. The mounting body 110 of the surface temperature sensor 100 is herein illustrated as already installed on the surface 200 by welding 300. A spacing is defined between the contact section 113, i.e., the apex 115a of the downwardly tapered main ridge 115, and the surface 200 by the spacing protrusions 117a, 117b (not shown in this figure). During the welding process, this spacing (also referred to as the defined gap) is completely filled by the welding material. Therefore, no air gaps 4000 remain after the welding process and the first junction 135 has a stable thermal coupling to the surface 200, as the welding material has very good thermal conducting characteristics. Also, the first junction 135, which is positioned right at the contact section 113, fixed into the first sensor element receptacle 114a by a welding 300′ that was done beforehand, is completely sealed from possibly detrimental environmental influences. For reliable full welding penetration between the contact section 130 and the surface 200, the height H of the spacing protrusions 117a, 117b is chosen to be at least 20% and not more than 200% of the width W of the contact section 113 (in this embodiment equal to the width of the flat intermediate section, that forms the apex 115a of the main ridge 115).

Although the above-mentioned beneficial effects are only explained in the context of the embodiment of FIGS. 2A and 2B, it should be understood that different embodiments of the first aspect of the invention, e.g. the alternative designs shown in FIGS. 3A, 4A and 5A, 5B, would still result with the same positive effects.

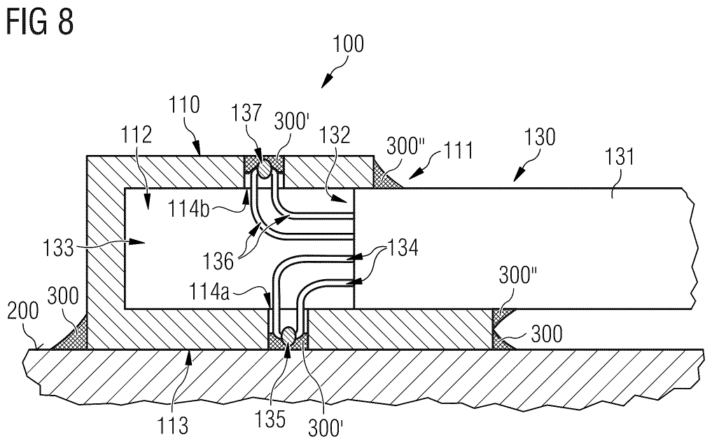

FIG. 8 illustrates an exemplary embodiment of a surface temperature sensor 100 according to the second aspect of the invention in a cross-sectional side view. The thermocouple sensor cable 130 is introduced into the insertion opening 111 of the mounting body 110. It is circumferentially welded to the edge of the insertion opening 111 by welding 300″ to fix it to the mounting body 110 and seal the insertion opening 111. Two pairs of dissimilar conductor wires 134, 136 extend from the opening 132 of the sheath 131 into the housing chamber 112. Leading ends of the first pair of dissimilar conductor wires 134 are connected to form the first junction 135, while leading ends of the second pair of dissimilar conductor wires 136 are connected to form the second junction 137. During manufacturing of the surface temperature sensor 100, the first pair of dissimilar conductor wires 134 is routed inside the housing chamber 112, so that the first junction 135 is placed inside the first sensor element receptacle 114a, and the second pair of dissimilar conductor wires 136 is routed inside the housing chamber 112, so that the second junction 137 is placed inside the second sensor element receptacle 114b. Both sensor element receptacles 114a, 114b are formed by bores through the walls of the mounting body 110. The first sensor element receptacle 114a is positioned on the bottom side of the mounting body 110 within the contact section 113. The second sensor element receptacle 114b is positioned on an upper side of the mounting body 110, that faces away from the ground. After the junctions 135, 137 are placed in their respective sensor element receptacles 114a, 114b, both receptacles 114a, 114b are each covered by a welding 300′. Thereby, the sensor element receptacles 114a, 114b are closed and sealed against the outside of the mounting body 110 and the junctions 135, 137 are fixed therein an in good thermal contact with surface sections of the mounting body 110 at their respective sensor element receptacle 114a, 114b. For completion of the manufacturing process, the inside of the housing chamber 112 is filled up with the same insulation material 133 as the thermocouple sensor cable 130. The surface temperature sensor 100 is installed to the surface 200 of a structure or object, whose surface temperature is to be measured, by circumferential welding 300. As the first junction 135 is arranged adjacent to the contact section 113, it is thermally coupled to the surface 200 and can be used to measure the surface temperature thereof. The second junction 137, which is arranged adjacent to the top surface of the mounting body 110, is in thermal contact with the atmosphere, surrounding the mounting body 110. It can therefore be used to measure an ambient temperature or also a surface temperature of the mounting body 110. If the surface temperature of the mounting body 110 is measured externally, e.g. with an infrared camera, the temperature measurement value from the second junction 137 can be calibrated with that. Furthermore, the temperature measurement values of the first junction 135 and second junction 137 can be compared to each other for the purpose of drift-or failure detection.

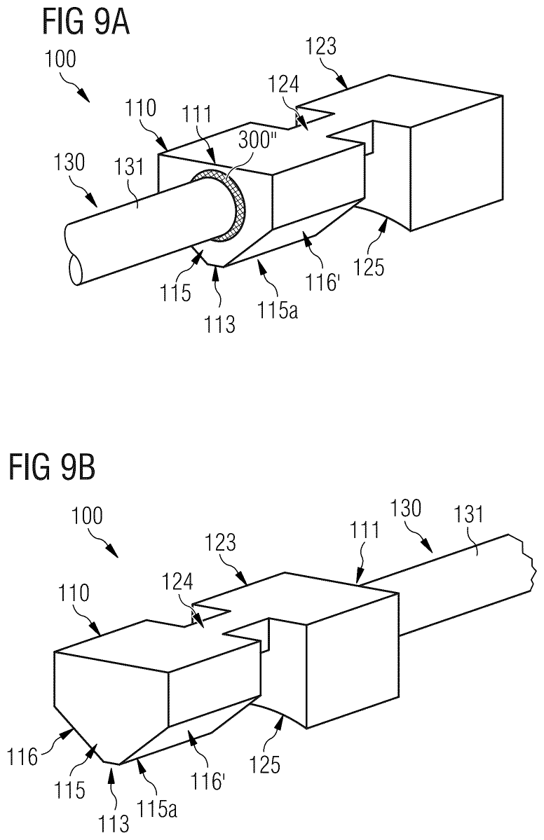

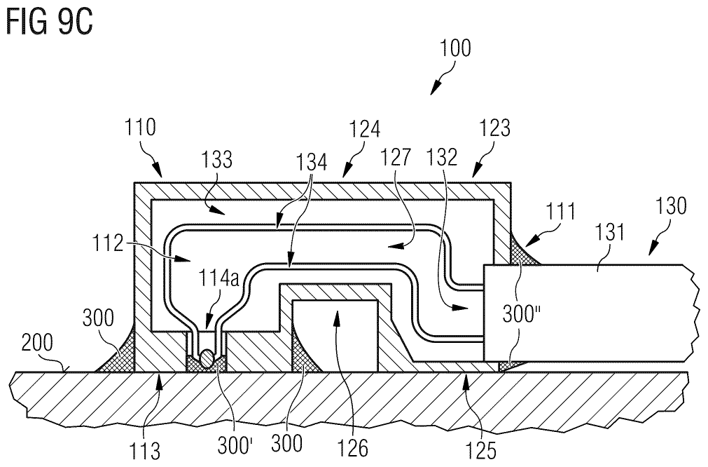

FIGS. 9A and 9B illustrate two exemplary embodiments of a surface temperature sensor 100 according to the third aspect of the invention in perspective views. Additionally, to the mounting body 110, which is present in all embodiments of the surface temperature sensor 100, this embodiment also comprises a positioning body 123 and a bridge body 124. The positioning body 123 has a shaped bottom side 125, which is adapted to match the shape of the surface 200, to which the surface temperature sensor 100 is to be attached to. In this example, the shaped bottom side 125 is formed corresponding to the curvature of a pipe for in-line installation (i.e., a longitudinal axis of the surface temperature sensor in parallel with the pipe). Therefore, when the surface temperature sensor 100 is placed on the surface 200 of a pipe, the positioning body 123 is in flat, areal contact with the surface 200 and provides for more stability during the installation process, particularly in comparison with simple V-shaped/knife-edged mounting bodies from the prior art. A chain clamp (or other clamping means) may be attached to the positioning body 123. As the bridge body 124 provides for a rigid connection between mounting body 110 and positioning body 123, no additional clamping of the mounting body 110 is then necessary before it is welded to the surface 200 and the risk of tilting or tipping of the mounting body 110 during the welding process is greatly reduced, if not eliminated, because of the stability gained with the flat, areal contact between the positioning body 123 and the surface 200.

FIG. 9A shows an exemplary embodiment wherein the insertion opening 111 is directly arranged on the mounting body 110, like it is the case with embodiments according to the other two aspects of the invention. However, FIG. 9B illustrates another exemplary embodiment, wherein the insertion opening 111 is arranged on a backside of the positioning body 123.

As illustrated in FIG. 9C, which shows the embodiment of FIG. 9B in in cross sectional side view, a guiding channel 127 is provided, that connects the insertion opening 111 with the housing chamber 112, so that the first pair of dissimilar conductor wires 134 can be routed from the opening 132 at the end of the metal sheath 131 to reach the first sensor element receptacle 114a. As the bottom side 126 of the bridge body 124 is recessed in relation to the contact section 113 of the mounting body 110 and the shaped bottom side 125 of the positioning body 123, the contact section's edges are accessible from all sides and the mounting body can be welded all around to the surface 200 by welding 300. The positioning body 123, however, does not need to be welded to the surface 200 completely circumferentially, since it does not need any defined, reliable thermal coupling to it, so it also does not need to be accessible from all sides. Therefore, the insertion opening 111 can be positioned such that the thermocouple sensor cable 130 can enter the insertion opening 111 almost flush with the surface 200, as shown in this figure. That makes routing of the thermocouple sensor cable 130 much easier and it is better protected from environmental influences.

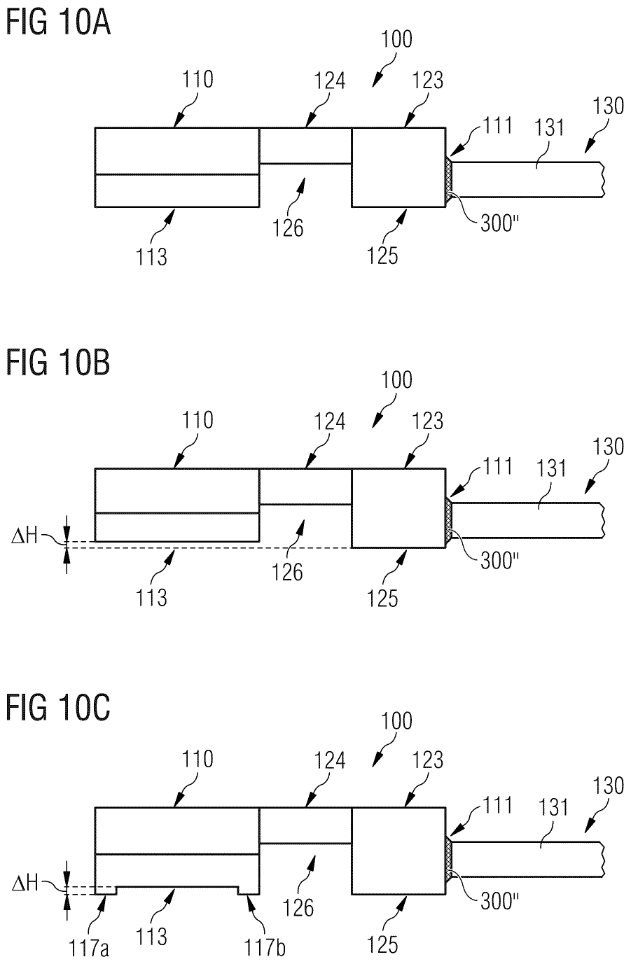

FIGS. 10A, 10B and 10C show further exemplary embodiments of surface temperature sensors 100 according to the third aspect of the invention in side views.

FIG. 10A basically shows an embodiment that corresponds to the embodiment shown in FIGS. 9B and 9C. Contact section 113 of the mounting body 110 and the shaped bottom side 125 of the positioning body 123 are adapted to both make contact with the surface 200 of an object or structure (not shown here).

FIG. 10B, however, shows an exemplary embodiment in which the contact section 113 of the mounting body 110 is recessed in relation to the shaped bottom side 125 of the positioning body 123, so that a defined gap for full welding penetration is formed below the contact section 113, when the surface temperature sensor 100 is placed on the surface 200.

FIG. 10C shows another exemplary embodiment, that is a combination of the first and third aspect of the invention: The contact section 113 is provided with spacing protrusions 117a, 117b, that provide for a defined gap between a middle section of the contact section 113 (where the first sensor element receptacle 114a and the first junction 135 are arranged in) for full welding penetration; the positioning body 123 with the shaped bottom surface 125 provides for a stable placement of the device on the surface 200, where it is to be installed, and reduces the risk of tilting or tipping during the welding process.

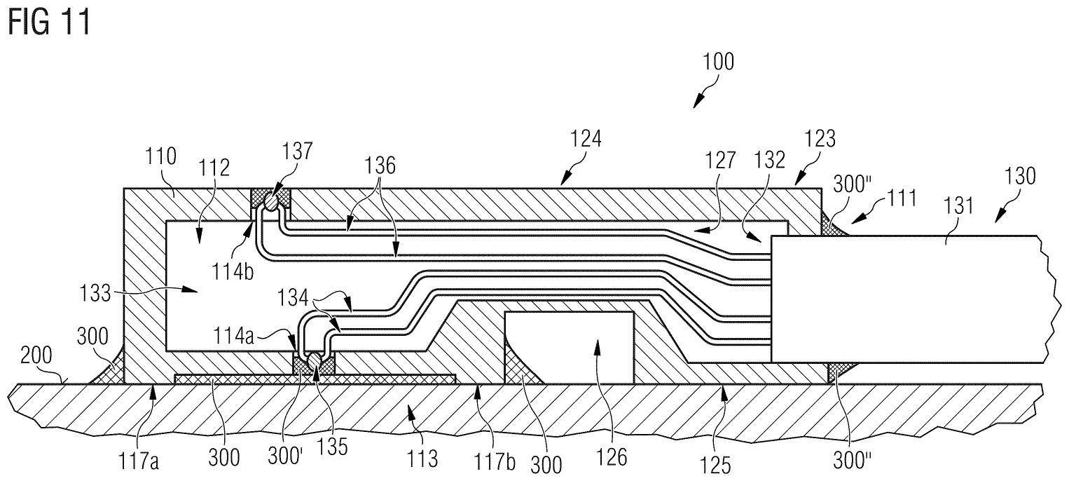

FIG. 11 shows another exemplary embodiment of a surface temperature sensor 100 that combines all three aspects of the present invention: It comprises the mounting body 100 with housing chamber 112, first sensor element receptacle 114a, second sensor element receptacle 114b and contact section 113, which is provided with two spacing protrusions 117a, 117b. It further comprises positioning body 123 with shaped bottom side 125 and the bridge body 124, which rigidly connects the mounting body 110 and the positioning body 123, and has a bottom side 126 that is recessed in relation to the contact section 113 and the shaped bottom side 125. The thermocouple sensor cable 130 is introduced into the insertion opening 111, which is arranged on the positioning body 123. Welding 300″ connects the end section of the sheath 131 to the positioning body 123 and seals the insertion opening 111. A first pair of dissimilar conductor wires 134 and a second pair of dissimilar conductor wires 136 extend from the opening 132 at the end of the sheath 131 and are routed through the guiding channel 127 to reach the housing chamber 112. Leading ends of the first pair of dissimilar conductor wires 134 are connected to form the first junction 135, while leading ends of the second pair of dissimilar conductor wires 136 are connected to form the second junction 137. During manufacturing of the surface temperature sensor 100, the first pair of dissimilar conductor wires 134 is routed inside the housing chamber 112, so that the first junction 135 is placed inside the first sensor element receptacle 114a, and the second pair of dissimilar conductor wires 136 is routed inside the housing chamber 112, so that the second junction 137 is placed inside the second sensor element receptacle 114b. Both sensor element receptacles 114a, 114b are formed in this example by bores through the walls of the mounting body 110. The first sensor element receptacle 114a is positioned on the bottom side of the mounting body 110 within the contact section 113. The second sensor element receptacle 114b is positioned on an upper side of the mounting body 110, that faces away from the ground. After the junctions 135, 137 are placed in their respective sensor element receptacles 114a, 114b, both receptacles 114a, 114b are each covered by a welding 300′. Thereby, the sensor element receptacles 114a, 114b are closed and sealed against the outside of the mounting body 110 and the junctions 135, 137 are fixed therein an in good thermal contact with surface sections of the mounting body 110 at their respective sensor element receptacle 114a, 114b. For completion of the manufacturing process, the inside of the housing chamber 112 and the guiding channel 127 are filled up with the same insulation material 133 as the thermocouple sensor cable 130. The surface temperature sensor 100 is installed to the surface 200 of a structure or object, whose surface temperature is to be measured, by circumferential welding 300. As the first junction 135 is arranged adjacent to the contact section 113, it is thermally coupled to the surface 200 and can be used to measure the surface temperature thereof. The second junction 137, which is arranged adjacent to the top surface of the mounting body 110, is in thermal contact with the atmosphere, surrounding the mounting body 110. Through the combination of the characteristic features of all three aspects of the present invention, the shown embodiment takes benefit of all advantageous effects, that are explained in the foregoing in the context of each single aspect and in the context of each corresponding exemplary embodiment of these.

A list of exemplary embodiments is given below:

Embodiment 1: Surface temperature sensor 100, comprising
a mounting body 110 made of a thermally conducting material, with
   an insertion opening 111,
   a housing chamber 112 accessible through the insertion opening 111,
   a contact section 113 at a bottom side of the mounting body 110,
   a first sensor element receptacle 114a that is accessible from within the housing chamber 112 and is positioned adjacent to the contact section 113, and
   a second sensor element receptacle 114b that is accessible from within the housing chamber 112 and is positioned adjacent to a top side of the mounting body 110, and
a thermocouple sensor cable 130 with
   a metal sheath 131 with an opening 132 at an end section,
   an insulation material 133 within the sheath 131,
   a first pair of dissimilar conductor wires 134 arranged within the sheath 131, and
   a second pair of dissimilar conductor wires 136 arranged within the sheath 131,
   wherein leading ends of the first pair and second pair of dissimilar conductor wires 134, 136 extend from the opening 132 at the end section of the metal sheath 131,
   wherein the ends of the first pair of dissimilar conductor wires 134 are connected to each other to form a first junction 135, and the ends of the second pair of dissimilar conductor wires 136 are connected to each other to form a second junction 137,
   wherein the end section of the thermocouple sensor cable 130 is inserted into the insertion opening 111 of the mounting body 110 and sealingly connected to it by welding 300″,
   wherein the first junction 135 is positioned in the first sensor element receptacle 114a and welded to the mounting body 110 within the first sensor element receptacle 114a, and
   wherein the second junction 137 is positioned in the second sensor element receptacle 114b and welded to the mounting body 110 within the second sensor element receptacle 114b.

Embodiment 2: Surface temperature sensor 100 according to embodiment 1, wherein the second pair of dissimilar conductor wires 136 comprise at least one conductor wire that is made of a different material than the conductor wires of the first pair of dissimilar conductor wires 134.

Embodiment 3: Surface temperature sensor 100 according to embodiment 1, wherein the contact section 113 is formed by an apex 115a of a downwardly tapered main ridge 115, which is defined by two inclined main faces 116, 116′ on the mounting body 110, wherein the main ridge 115 extends at least partially along a longitudinal axis of the mounting body 110 and the first sensor element receptacle 114a is positioned within the main ridge 115.

Embodiment 4: Surface temperature sensor 100 according to embodiment 1 wherein the mounting body 110 further comprises at least one spacing protrusion 117a, 117b on or adjacent to the contact section 113, that protrudes beyond an outer surface of the contact section 113.

Embodiment 5: Surface temperature sensor according to embodiment 4, wherein the at least one spacing protrusion 117a, 117b protrudes 0.02 inches to 0.13 inches beyond the outer surface of the contact section 113.

Embodiment 6: Surface temperature sensor 100 according to embodiment 4, wherein a height H of the at least one spacing protrusion 117a, 117b is at least 20% and not more than 200% of a width W of the contact section 113.

Embodiment 7: Surface temperature sensor 100 according to embodiment 4, wherein the mounting body 110 comprises at least two spacing protrusions 117a, 117b,
wherein the first sensor element receptacle 114a is positioned between a first and a second spacing protrusion 117a, 117b of the at least two spacing protrusions 117a, 117b, essentially in the middle of a straight line between the first and second spacing protrusion 117a, 117b.

Embodiment 8: Surface temperature sensor 100 according to embodiment 4 wherein the contact section 113 is formed by an apex 115a of a downwardly tapered main ridge 115, which is defined by two inclined main faces 116, 116′ on the mounting body 110,
wherein the main ridge 115 extends at least partially along a longitudinal axis of the mounting body 110 and the first sensor element receptacle 114a is positioned within the main ridge 115,
wherein the at least one spacing protrusion 117a, 117b is formed by a secondary ridge 118a, 118b, which is defined by two inclined secondary faces 119a, 119a′, 119b, 119b′, and
wherein the secondary ridge 118a, 118b is formed on or adjacent to the main ridge 115.

Embodiment 9: Surface temperature sensor 100 according to embodiment 8, wherein the two inclined main faces 116, 116′ are tilted by an angle αₚᵣᵢₘ of 90° to 140° between each other.

Embodiment 10: Surface temperature sensor 100 according to embodiment 9, wherein the two inclined secondary faces 119a, 119a′, 119b, 119b′ are tilted by an angle α_{sec} between each other, that is smaller than the angle αₚᵣᵢₘ between the inclined main faces 116, 116′ of the main ridge 115.

Embodiment 11: Surface temperature sensor 100 according to embodiment 4, wherein the contact section 113 is formed by an apex 115a of a downwardly tapered main ridge 115, which is defined by two inclined main faces 116, 116′ on the mounting body 110,
wherein the main ridge 115 extends at least partially along a longitudinal axis of the mounting body 110 and the first sensor element receptacle 114a is positioned within the main ridge 115,
wherein the main ridge 115 comprises
   a sensing section 120 that is recessed, and
   at least one spacing section, that is either not recessed or less recessed than the sensing section 120,
wherein the at least one spacing protrusion 117a, 117b is formed by that at least one spacing section and
wherein the first sensor element receptacle 114a is positioned within the sensing section 120.

Embodiment 12: Surface temperature sensor 100, comprising
a mounting body 110 made of a thermally conducting material, with
   a housing chamber 112,
   a contact section 113 at a bottom side of the mounting body 110, and
   a first sensor element receptacle 114a that is accessible from within the housing chamber 112 and is positioned adjacent to the contact section 113,
a thermocouple sensor cable 130 with
   a metal sheath 131 with an opening 132 at an end section,
   an insulation material 133 within the sheath 131, and
   a first pair of dissimilar conductor wires 134 arranged within the sheath 131,
a positioning body 123 with
   a shaped bottom side 125 that matches a surface 200 that the surface temperature sensor 100 is to be mounted on, and
a bridge body 124,
   wherein the bridge body 124 rigidly connects the positioning body 123 and the mounting body 110 and a bottom side 126 of the bridge body 124 is recessed in relation to the contact section 113 and the shaped bottom side 125,
   wherein an insertion opening 111 is arranged on either the mounting body 110, the bridge body 124 or the positioning body 123, and
   the housing chamber 112 is accessible through the insertion opening 111,
   wherein leading ends of the dissimilar conductor wires extend from the opening 132 at the end section of the metal sheath 131,
   wherein the ends of the first pair of dissimilar conductor wires 134 are connected to each other to form a first junction 135,
   wherein the end section of the thermocouple sensor cable 130 is inserted into the insertion opening 111 and sealingly connected to it by welding 300″,
   wherein the first junction 135 is positioned in the first sensor element receptacle 114a and welded to the mounting body 110 within the first sensor element receptacle 114a.

Embodiment 13: Surface temperature sensor 100 according to embodiment 12, wherein the contact section 113 is slightly recessed in relation to the shaped bottom side 125 of the positioning body 123.

Embodiment 14: Surface temperature sensor 100 according to embodiment 12, wherein
the mounting body 110 further comprises a second sensor element receptacle 114b that is accessible from within the housing chamber 112 and is positioned adjacent to a top side of the mounting body 110, and
the thermocouple sensor cable 130 comprises a second pair of dissimilar conductor wires 136 arranged within the sheath 131,
wherein leading ends of the second pair of dissimilar conductor wires 136 extend from the opening 132 at the end section of the metal sheath 131,
wherein the ends of the second pair of dissimilar conductor wires 136 are connected to each other to form a second junction 137,
wherein the second junction 137 is positioned in the second sensor element receptacle 114b and welded to the mounting body 110 within the second sensor element receptacle 114b.

Embodiment 15: Surface temperature sensor 100 according to embodiment 14,
wherein the second pair of dissimilar conductor wires 136 comprise at least one conductor wire that is made of a different material than the conductor wires of the first pair of dissimilar conductor wires 134.

Embodiment 16: Surface temperature sensor 100 according to embodiment 12, wherein the contact section 113 is formed by an apex 115a of a downwardly tapered main ridge 115, which is defined by two inclined main faces 116, 116′ on the mounting body 110,
wherein the main ridge 115 extends at least partially along a longitudinal axis of the mounting body 110 and the first sensor element receptacle 114a is positioned within the main ridge 115.

Embodiment 17: Surface temperature sensor 100 according to embodiment 12, wherein the mounting body 110 further comprises at least one spacing protrusion 117a, 117b on or adjacent to the contact section 113, that protrudes beyond an outer surface of the contact section 113.

Embodiment 18: Surface temperature sensor 100 according to embodiment 17, wherein the at least one spacing protrusion 117a, 117b protrudes 0.02 inches to 0.13 inches beyond the outer surface of the contact section 113.

Embodiment 19: Surface temperature sensor 100 according to embodiment 17, wherein a height H of the at least one spacing protrusion 117a, 117b is at least 20% and not more than 200% of a width W of the contact section 113.

Embodiment 20: Surface temperature sensor 100 according to embodiment 17, wherein the mounting body 110 comprises at least two spacing protrusions 117a, 117b,
wherein the first sensor element receptacle 114a is positioned between a first and a second spacing protrusion 117a, 117b of the at least two spacing protrusions 117a, 117b, essentially in the middle of a straight line between the first and second spacing protrusion 117a, 117b.

Embodiment 21: Surface temperature sensor 100 according to embodiment 17, wherein the contact section 113 is formed by an apex 115a of a downwardly tapered main ridge 115, which is defined by two inclined main faces 116, 116′ on the mounting body 110,
wherein the main ridge 115 extends at least partially along a longitudinal axis of the mounting body 110 and the first sensor element receptacle 114a is positioned within the main ridge 115,
wherein the at least one spacing protrusion 117a, 117b is formed by a secondary ridge 118a, 118b, which is defined by two inclined secondary faces 119a, 119a′, 119b, 119b′, and
wherein the secondary ridge 118a, 118b is formed on or adjacent to the main ridge 115.

Embodiment 22: Surface temperature sensor 100 according to embodiment 21, wherein the two inclined main faces 116, 116′ are tilted by an angle αₚᵣᵢₘ of 90° to 140° between each other.

Embodiment 23: Surface temperature sensor 100 according to embodiment 22, wherein the two inclined secondary faces 119a, 119a′, 119b, 119b′ are tilted by an angle α_{sec} between each other, that is smaller than the angle &prim between the inclined main faces 116, 116′ of the main ridge 115.

Embodiment 24: Surface temperature sensor 100 according to embodiment 17, wherein the contact section 113 is formed by an apex 115a of a downwardly tapered main ridge 115, which is defined by two inclined main faces 116, 116′ on the mounting body 110, wherein the main ridge 115 extends at least partially along a longitudinal axis of the mounting body 110 and the first sensor element receptacle 114a is positioned within the main ridge 115,
wherein the main ridge 115 comprises
   a sensing section 120 that is recessed, and
   at least one spacing section, that is either not recessed or less recessed than the sensing section 120,
wherein the at least one spacing protrusion 117a, 117b is formed by that at least one spacing section and
wherein the first sensor element receptacle 114a is positioned within the sensing section 120.

### REFERENCE NUMBERS

100 Surface temperature sensor
110 Mounting body
111 Insertion opening
112 Housing chamber
113 Contact section
114a First sensor element receptacle
114b Second sensor element receptacle
115 Main ridge
115a Apex of main ridge
116, 116′ Inclined main face
117a, 117b Spacing protrusion
118a, 118b Secondary ridge
119a, 119a′, 119b, 119b′ Inclined secondary face
αₚᵣᵢₘ Angle between main faces
α_{sec} Angle between secondary faces
120 Sensing section
121, 121′ Side edge of main faces
122, 122′ Side edge of secondary faces
123 Positioning body
124 Bridge body
125 Shaped bottom side
126 Bottom side of bridge body
127 Guiding channel
130 Thermocouple sensor cable
131 Metal sheath
132 Opening
133 Insulation material
134 First pair of dissimilar conductor wires
135 First junction
136 Second pair of dissimilar conductor wires
137 Second junction
200 Surface
300, 300′, 300″ Welding
1000 Temperature sensor
1100 Mounting body
1110 Insertion opening
1120 Housing chamber
1130 Contact section
1140 Sensor element receptacle
1150 Ridge
1150a Apex of ridge
1160, 1160′ Inclined main face
1300 Thermocouple sensor cable
1310 Metal sheath
1320 Opening
1330 Inorganic insulation material
1340 First pair of dissimilar conductors
1350 Thermocouple junction
2000 Surface
3000, 3000′, 3000″ Welding
4000 Air gap
H Height
W Width

1. A surface temperature sensor, comprising:
a mounting body made of a thermally conducting material, with
an insertion opening,
a housing chamber accessible through the insertion opening,
a contact section at a bottom side of the mounting body, and
a first sensor element receptacle that is accessible from within the housing chamber and is positioned adjacent to the contact section, and
a thermocouple sensor cable with
a metal sheath with an opening at an end section,
an insulation material within the sheath, and
a first pair of dissimilar conductor wires arranged within the sheath,
wherein leading ends of the dissimilar conductor wires extend from the opening at the end section of the metal sheath, wherein the ends of the first pair of dissimilar conductor wires are connected to each other to form a first junction,
wherein the end section of the thermocouple sensor cable is inserted into the insertion opening of the mounting body and sealingly connected to it by welding,
wherein the first junction is positioned in the first sensor element receptacle and welded to the mounting body within the first sensor element receptacle,
wherein the mounting body further comprises at least one spacing protrusion on or adjacent to the contact section, that protrudes beyond an outer surface of the contact section.

2. The surface temperature sensor according to claim 1, wherein the at least one spacing protrusion protrudes 0.02 inches to 0.13 inches beyond the outer surface of the contact section.

3. The surface temperature sensor according to claim 1, wherein a height of the at least one spacing protrusion is at least 20% and not more than 200% of a width of the contact section.

4. The surface temperature sensor according to claim 1, wherein the mounting body comprises at least two spacing protrusions, wherein the first sensor element receptacle is positioned between a first and a second spacing protrusion of the at least two spacing protrusions, essentially in the middle of a straight line between the first and second spacing protrusions.

5. The surface temperature sensor according to claim 1, wherein the contact section is formed by an apex of a downwardly tapered main ridge, which is defined by two inclined main faces on the mounting body, wherein the main ridge extends at least partially along a longitudinal axis of the mounting body and the first sensor element receptacle is positioned within the main ridge.

6. The surface temperature sensor according to claim 5, wherein the inclined main faces are tilted by an angle (αₚᵣᵢₘ) of 90° to 140° between each other.

7. The surface temperature sensor according to claim 5, wherein the at least one spacing protrusion is formed by a downwardly tapered secondary ridge, which is defined by two inclined secondary faces, wherein the secondary ridge is formed on or adjacent to the main ridge.

8. The surface temperature sensor according to claim 7, wherein the secondary faces are tilted by an angle (α_{sec}) between each other, that is smaller than or equal to the angle (αₚᵣᵢₘ) between the inclined main faces of the main ridge.

9. The surface temperature sensor according to claim 5, wherein the main ridge comprises:
a sensing section that is recessed, and
at least one spacing section, that is either not recessed or less recessed than the sensing section,
wherein the at least one spacing protrusion is formed by that at least one spacing section and
wherein the first sensor element receptacle is positioned within the sensing section.

10. The surface temperature sensor according to claim 1, wherein
the mounting body comprises a second sensor element receptacle that is accessible from within the housing chamber and is positioned adjacent to a top side of the mounting body, and
the thermocouple sensor cable comprises a second pair of dissimilar conductor wires arranged within the sheath,
wherein leading ends of the second pair of dissimilar conductor wires extend from the opening at the end section of the metal sheath,
wherein the ends of the second pair of dissimilar conductor wires are connected to each other to form a second junction, and
wherein the second junction is positioned in the second sensor element receptacle and welded to the mounting body within the second sensor element receptacle.

11. The surface temperature sensor according to claim 10, wherein the second pair of dissimilar conductor wires comprise at least one conductor wire that is made of a different material than the conductor wires of the first pair of dissimilar conductor wires.

12. The surface temperature sensor according to claim 1, comprising:
a positioning body with
a shaped bottom side that matches a surface that the surface temperature sensor is to be mounted on, and
a bridge body,
wherein the bridge body rigidly connects the positioning body and the mounting body and a bottom side of the bridge body is recessed in relation to the contact section and the shaped bottom side.

13. The surface temperature sensor according to claim 12, wherein the contact section is slightly recessed in relation to the shaped bottom side of the positioning body.

14-37. (canceled)

38. A surface temperature sensor, comprising:
a mounting body made of a thermally conducting material and having an insertion opening;
a housing chamber accessible through the insertion opening;
a contact section at a bottom side of the mounting body;
a first sensor element receptacle accessible from within the housing chamber and positioned adjacent to the contact section, and a thermocouple sensor cable with a metal sheath with an opening at an end section,
an insulation material within the sheath, and a first pair of dissimilar conductor wires arranged within the sheath,
wherein leading ends of the dissimilar conductor wires extend from the opening at the end section of the metal sheath, wherein the ends of the first pair of dissimilar conductor wires are connected to each other to form a first junction,
wherein the end section of the thermocouple sensor cable is inserted into the insertion opening of the mounting body and sealingly connected to it by welding,
wherein the first junction is positioned in the first sensor element receptacle and welded to the mounting body within the first sensor element receptacle,
wherein the mounting body further comprises at least one spacing protrusion on or adjacent to the contact section, that protrudes beyond an outer surface of the contact section.
